(19) United States
(12) Patent Application Publication
(10) Pub. No.: US 2025/0308812 A1
(43) Pub. Date: Oct. 2, 2025

(54) SWITCH DEVICE

(71) Applicant: TOYO DENSO KABUSHIKI KAISHA, TOKYO (JP)

(72) Inventors: Narumi SUZUKI, Saitama (JP); Yoshiaki SUGAWARA, Saitama (JP); Tetsuya HIGASHIDA, Saitama (JP)

(73) Assignee: TOYO DENSO KABUSHIKI KAISHA, TOKYO (JP)

(21) Appl. No.: 19/066,650

(22) Filed: Feb. 28, 2025

(30) Foreign Application Priority Data
Mar. 29, 2024 (JP) 2024-055599

(51) Int. Cl. H01H 13/02

(52) U.S. Cl. CPC H01H 13/023; H01H 2231/026

(57) ABSTRACT

A switch device of the present disclosure includes: an operation unit that has a light emitting region at a part formed with a light-transmissive member and is operated by pressing; a support unit formed with a light-transmissive member, provided with an internal space, and connected to the light emitting region of the operation unit to support the operation unit; a contact structure turned on/off; and a light emitting element emitting light toward the internal space of the support unit. The external shape of the support unit in a substantially perpendicular direction to the pressing direction is formed smaller than the light emitting region and, on an inner wall surface forming the internal space of the support unit, a plurality of convex portions protruding from the inner wall surface are provided.

### INCORPORATION BY REFERENCE

This application is based upon and claims the benefit of priority from Japanese patent application No. 2024-055599, filed on Mar. 29, 2024, the disclosure of which is incorporated herein in its entirety by reference.

### TECHNICAL FIELD

The present disclosure relates to a switch device.

### BACKGROUND ART

A switch device installed in a vehicle is, for example, a switch device in which a light emitting unit is formed on the surface of an operation knob as described in Patent Literature 1. To be specific, in the switch device described in Patent Literature 1, a circuit board is placed in a case that supports the operation knob, and light from a light emitting element mounted on the circuit board passes from the reverse side to the surface side of the operation knob, so that a light emitting part is formed. Then, in the switch device of Patent Literature 1, in order to make the entire light emitting part of a predetermined size uniformly emit light, the internal space of the case forming an optical path from the light emitting element to the light emitting part is formed to be large in width, and furthermore, the thickness of the top surface of the operation knob which the light enters is adjusted.

Patent Literature 1: Japanese Unexamined Patent Application Publication No. JP-A 2018-194677

However, in the switch device described in Patent Literature 1 as described above, there is a need to make the width of the internal space of the case supporting the operation knob larger than the size of the light emitting part, resulting in a decrease in the degree of freedom in design. That is to say, in a case where a support structure with a narrow inner space or external shape is adopted, the optical path from the light emitting element to the light emitting part becomes narrow, and it is difficult to make the top surface into a thickness-adjusted structure, resulting in a difficulty in making the entire light emitting region uniformly emit light.

### SUMMARY OF THE INVENTION

Accordingly, an object of the present disclosure is to provide a switch device that can solve a problem that in the case of adopted a support structure of a narrow width for an operation knob, it is difficult to make a light emitting region on the operation knob uniformly emit light.

A switch device as an aspect of the present disclosure includes: an operation unit that is provided with a light emitting region set at a part formed with a light-transmissive member, the operation unit being operated by pressing; a support unit formed with a light-transmissive member and provided with an internal space formed to extend along a pressing direction in the operation by pressing, one end side in the pressing direction being connected to the light emitting region of the operation unit and supporting the operation unit; a contact structure that is turned on and off by movement of the support unit along the pressing direction; and a light emitting element that emits light toward the one end side from an other end side of the internal space of the support unit. An external shape of the support unit in a substantially perpendicular direction to the pressing direction is formed smaller than the light emitting region and, on an inner wall surface that forms the internal space of the support unit, a plurality of convex portions protruding from the inner wall surface are provided.

With the configuration as described above, the present disclosure can provide a switch device in which it is possible to make a light emitting region on an operation knob uniformly emit light even in the case of adopting a support structure of a narrow width for the operation knob.

### BRIEF DESCRIPTION OF DRAWINGS

FIG. 1 is a schematic cross-section view of a switch device of the present disclosure;

FIG. 2 is a cross-section view showing a configuration of an operation knob configuring the switch device disclosed in FIG. 1;

FIG. 3 is an enlarged cross-section view of part of the operation knob disclosed in FIG. 2; and

FIG. 4 is a diagram showing a state of light emission in the switch device disclosed in FIG. 1.

### EXAMPLE EMBODIMENT

### First Example Embodiment

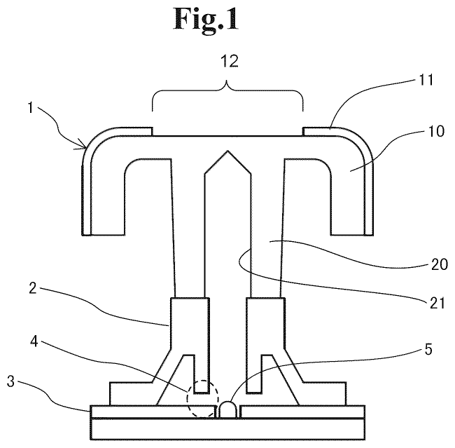

A first example embodiment of the present disclosure will be described with reference to FIGS. 1 to 4. FIG. 1 shows a schematic cross-section view of a switch device, and the illustration of hatching is omitted.

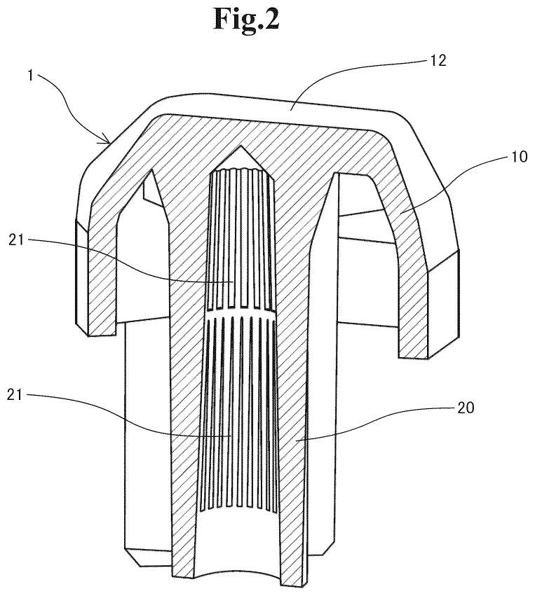

The switch device in this example embodiment is a push-button-type switch device provided in a vehicle, and includes an operation knob 1 to be operated by pressing as shown in FIG. 1. A cross-section view of the operation knob 1 is shown in FIG. 2, and a direction from the top to the bottom in FIGS. 1 and 2 is a pressing direction. Then, as will be described later, the operation knob 1 is moved downward, that is, along the pressing direction by operation by pressing of an operation face formed at a center portion of an outer surface located on the upper side to the lower side. In the following description, a downward direction in FIG. 1 will be referred to as a pressing direction, a side opposite to the pressing direction will be referred to as one end side, and a side in the pressing direction will be referred to as the other end side.

The operation knob 1 includes an operation unit 10 that forms an operation portion located on the upper side and a support unit 20 located on the lower side in FIG. 1. Here, the operation unit 10 and the support unit 20 are integrally molded and formed with a light-transmissive member that is transparent or translucent. Meanwhile, the operation knob 1 is not necessarily limited to the configuration that the operation unit 10 and the support unit 20 are integrally molded, and may be configured in such a manner that the operation unit 10 and the support unit 20 are configured with different members from each other and are connected. The configuration of the operation knob 1 will be described in detail later.

Further, the switch device includes, on the lower side of the operation knob 1, a substrate 3 and a rubber contact 2 mounted on the substrate 3. The rubber contact 2 is formed with an elastic member whose shape can be changed, and an end on the upper side thereof abuts on an end on the lower side of the operation knob 1. At an opposing portion in the vicinity of the center portions of the rubber contact 2 and substrate 3, that is, at a portion of an end on the lower side of the rubber contact 2 and the substrate 3 opposing the end, a contact structure 4 that shifts a switch from a turned-off state to a turned-on state upon mutual contact is formed. With such a configuration, the rubber contact 2 is pressed downward and deformed in accordance with the downward movement of the operation knob 1 operated by pressing, and the end on the lower side of the rubber contact 2 moves in such a manner as to come into contact with the substrate 3. For example, FIG. 1 shows a state in which the operation knob 1 is not operated by pressing, and the end on the lower side of the rubber contact 2 is spaced from the substrate 3 and the contact structure 4 is in the turned-off state. When the operation knob 1 is operated by pressing from the above state, the operation knob 1 moves downward and, in accordance with this, the end on the lower side of the rubber contact 2 moves toward the substrate 3 and comes into contact with the substrate 3, so that the contact structure 4 is in the turned-on state. When the pressing state of the operation knob 1 is released, the deformation of the rubber contact 2 is restored, and the contact structure 4 is in the turned-off state.

An internal space is formed along the pressing direction in the center portion of the rubber contact 2. Then, the internal space of the rubber contact 2 communicates with an internal space formed in the support unit 20 that is a part on the lower side of the operation knob 1 to be described later.

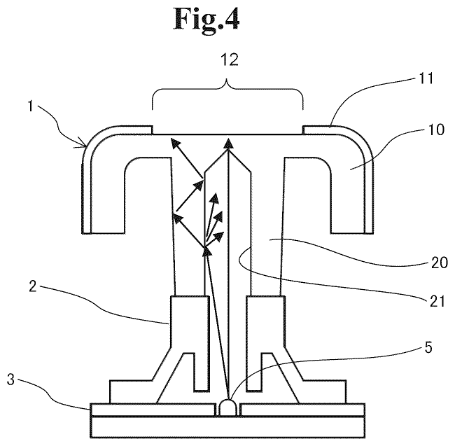

Further, the switch device includes a light emitting element 5 such as an LED (Light Emitting Diode) mounted on the substrate 3. The light emitting element 5 is placed on the lower side in the vicinity of the center portion with the contact structure provided of the rubber contact 2 described above, and opposes the internal space of the rubber contact 2. Therefore, the light emitting element 5 emits light toward the internal space formed in the vicinity of the center portion of the rubber contact 2. Moreover, in accordance with this, the internal space of the rubber contact 2 communicates with the internal space formed in the support unit 20 that is the part on the lower side of the operation knob 1, so that the light of the light emitting element 5 is also emitted to the internal space of the support unit 20. For example, as shown by arrow in FIG. 4, the light from the light emitting element 5 passes through the internal space of the rubber contact 2 and is applied to the internal space formed in the support unit 20 of the operation knob 1.

Now, the operation knob 1 mentioned above will be described in detail. As shown in FIGS. 1 and 2, the operation unit 10 located on the upper side of the operation knob 1 has a predetermined breadth of an outer surface on the upper side, and forms an operation face having a predetermined external shape. At this time, the outer surface of the operation unit 10 is covered by a light shielding member 11 only on the periphery excluding a predetermined region of the center portion. For example, the light shielding member 11 is a coating having a light shielding property. Consequently, the region having a predetermined breadth at the center portion of the outer surface of the operation unit 10 formed by the light-transmissive member is exposed to the outside and is formed as a light emitting region 12 irradiated with light transmitted from the internal side. In this example embodiment, the entire operation unit 10 is formed with the light-transmissive member, and the emit lighting region 12 is formed in the center portion by covering only the periphery with the light-shielding member 11, but the light emitting region 12 may be formed by forming only a part in the vicinity of the center portion with the light-transmissive member.

Further, the support unit 20 located on the lower side of the operation knob 1 is formed in a substantially cylindrical shape in which the internal space extends along the pressing direction. At this time, an external shape in a substantially perpendicular direction to the pressing direction of the support unit 20 is formed smaller than the size of the light emitting region 12 described above. For example, in a case where the light emitting region 12 is substantially circular and the support unit 20 is substantially cylindrical, the outer diameter of the support unit 20 is formed smaller than the diameter of the light emitting region 12. Therefore, the interior of the internal space of the support unit 20 is formed smaller than the external shape of the light emitting region 12.

Then, as shown in FIGS. 1 and 2, the end on the upper side of the support unit 20 is connected to the operation unit 10 described above at the light emitting region 12 formed at the center portion of the operation unit 10. That is to say, the end on the upper side of the substantially cylindrical support unit 20 is connected to the reverse side opposite to the outer surface side of the light emitting region 12 of the operation unit 10.

Further, the internal space of the substantially cylindrical support unit 20 extends along the pressing direction as described above, and communicates with the internal space formed in the rubber contact 2. Therefore, the internal space of the support unit 20 is placed in such a manner as to oppose the light emitting element 5 mounted on the substrate 3, so that the light from the light emitting element 5 passes through the internal space of the rubber contact 2 and is emitted.

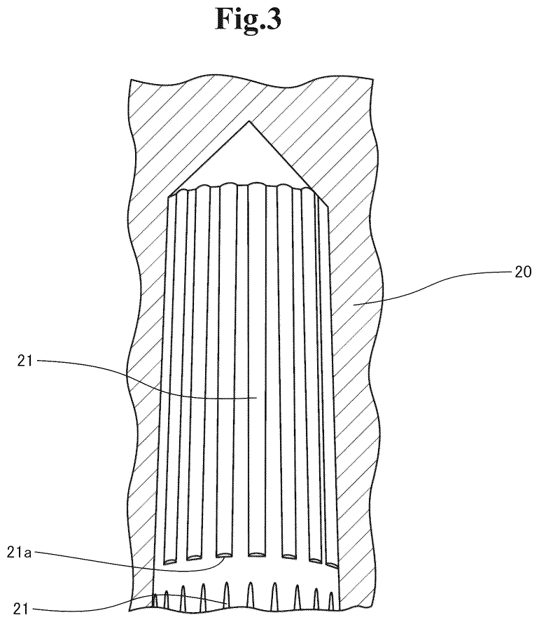

FIG. 3 shows an enlarged view of the internal space of the support unit 20 shown in FIG. 2. As shown in this view, on the inner wall surface of the internal space of the support unit 20, a plurality of convex portions 21 protruding from the inner wall are formed. To be specific, the convex portion 21 is formed in a streak extending along the vertical direction of FIG. 2, that is, the pressing direction of the operation knob 1, and the protrusion outer surface thereof is formed in a curved surface. As an example, a cross-section shape in a substantially perpendicular direction to a longitudinal direction of the streaky convex portion 21 is formed in a substantially semicircular shape or a substantially semi-elliptic shape. Meanwhile, the outer surface of the convex portion 21 may be any curved shape, and is not limited to a curved shape but may be any shape such as a polyhedral shape. Thus, by making the outer surface of the convex portion 21 a shape that is not a single plane, light emitted by the light emitting element 5 can be reflected or diffused to the other surface.

Further, in this example embodiment, the plurality of streaky convex portions 21 are placed in parallel along the inner circumferential direction of the inner wall surface surrounding the internal space of the support unit 20 as shown in FIG. 3. To be specific, the plurality of streaky convex portions 21 are formed in such a manner as to be placed substantially in parallel. Furthermore, in this example embodiment, as shown in FIG. 2, the plurality of streaky convex portions 21 are not uniformly formed in the internal space from the one end side that is the operation unit 10 side to the other end side that is the rubber contact 2 side, and are formed separately on the one end side and the other end side, respectively. At this time, the streaky convex portion 21 on the other end side of the internal space may be located on the extension of the streaky convex portion 21 on the one end side, or may not necessarily be located on the extension. Further, the number of the streaky convex portions 21 on the one end side of the internal space and the number of the streaky convex portions 21 on the other end side may be the same or different. The internal space of the support unit 20 may be formed to gradually widen from the one end side that is the operation unit 10 side to the other end side that is the rubber contact 2 side. In this case, it may be formed in such a manner that the number of streaky convex portions on the other end side is greater than the number of steaky convex portions 21 on the one end side by making the intervals between the streaky convex portions 21 even.

Further, in this example embodiment, as shown in FIG. 3, the end on the other end side of the streaky convex portion 21 is formed with an inclined surface 21a having a predetermined angle to the pressing direction. For example, at the time of molding using a resin material, a draft angle may be provided, and the inclined surface 21a is formed with a surface extending along the angle between the pressing direction and the perpendicular direction to the pressing direction. Consequently, the inclined surface 21a is formed with a surface that inclines toward the lower side, that is, the light emitting element 5 side.

Next, a state of light emission in the switch device of the above structure will be described. As shown in FIG. 4, light emitted by the light emitting element 5 mounted on the substrate 3 passes through the internal space formed in the rubber contact 2, and enters the internal space formed in the support unit 20 of the operation knob 1. Arrow in FIG. 4 indicates the direction of the light. At this time, the light having entered the internal space of the support unit 20 of the operation knob 1 and applied toward the internal wall surface enters the internal wall surface that is the light-transmissive member or is reflected on the internal wall surface.

Then, the light incident inside the inner wall surface of the operation knob 1 is reflected at the boundary of the inner wall surface while transmitted through the inner wall surface that is a light-transmissive member, repeatedly transmitted and reflected, and is emitted from the light emitting region 12 to the outside. The inclined surface 21a formed on the other end of the streaky convex portion 21 formed in the inner wall surface is formed facing toward the light emitting element 5, and the light emitted by the light emitting element 5 is incident inside the inner wall surface on the inclined surface 21a. Therefore, the amount of light entering inside the inner wall surface of the operation knob 1 increases, and the light emission amount of light from the light emitting region 12 to the outside can be increased.

Further, the light reflected by the inner wall surface is reflected in all directions in the internal space by the abovementioned convex portions 21 formed on the inner wall surface. That is to say, the light is diffusely reflected by the surface formed by the curved surface of the convex portion 21 or the like into the internal space, and the irradiation region expands. Furthermore, in the same manner as described above, the diffusely reflected light is repeatedly incident and diffusely reflected on the inner wall surface at other portions of the internal space and emitted to the outside from the light emitting region 12. Consequently, the light emitting region 12 is made to entirely uniformly emit light.

As described above, in a case where the support unit 20 with a narrow external shape such as width with respect to the light emitting region 12 formed at the operation knob 1 is adopted, the switch device in this example embodiment includes the convex portions 21 on the inner wall surface of the internal space in the support unit 20 through which light from the light emitting element 5 is transmitted. Consequently, the light is diffusely reflected on the inner wall surface of the internal space, so that the light emitting region 12 can be made to uniformly emit the light.

### Supplementary Notes

The whole or part of the example embodiments disclosed above can be described as the following supplementary notes. Below, the overview of a switch device in the present invention will be described. However, the present invention is not limited to the following configurations.

### (Supplementary Note 1)

A switch device comprising:
an operation unit that is provided with a light emitting region set at a part formed with a light-transmissive member, the operation unit being operated by pressing;
a support unit formed with a light-transmissive member and provided with an internal space formed to extend along a pressing direction in the operation by pressing, one end side in the pressing direction being connected to the light emitting region of the operation unit and supporting the operation unit;
a contact structure that is turned on and off by movement of the support unit along the pressing direction; and
a light emitting element that emits light toward the one end side from an other end side of the internal space of the support unit, wherein:
an external shape of the support unit in a substantially perpendicular direction to the pressing direction is formed smaller than the light emitting region; and
on an inner wall surface that forms the internal space of the support unit, a plurality of convex portions protruding from the inner wall surface are provided.

### (Supplementary Note 2)

The switch device according to supplementary note 1, wherein
the convex portion is formed in a streak shape extending along the pressing direction.

### (Supplementary Note 3)

The switch device according to supplementary note 2, wherein
an external surface of the convex portion is formed in a curved surface.

### (Supplementary Note 4)

The switch device according to supplementary note 2, wherein
the plurality of convex portions each formed in the streak shape extending along the pressing direction are arranged in parallel along an inner circumferential direction of the inner wall surface surrounding the internal space of the support unit.

### (Supplementary Note 5)

The switch device according to supplementary note 2, wherein
the convex portions each formed in the streak shape extending along the pressing direction are formed separately on the one end side and the other end side in the pressing direction sandwiching a predetermined location along the pressing direction.

### (Supplementary Note 6)

The switch device according to supplementary note 2, wherein
an end on the other end side in the pressing direction of the convex portion formed in the streak shape is formed with an inclined surface having a predetermined angle to the pressing direction.

### (Supplementary Note 7)

The switch device according to supplementary note 1, wherein
the operation unit and the support unit are formed with an integrally molded light-transmissive member.

Although the present invention has been described above with reference to the above-described example embodiments, the present invention is not limited to the example embodiments described above. The configuration and details of the present invention can be changed in various manners that can be understood by those skilled in the art within the scope of the present invention.

### Description of Reference Numerals

1 operation knob
2 rubber contact
3 substrate
4 contact structure
5 light emitting element
10 operation unit
11 light shielding member
12 light emission region
20 support unit
21 convex portion
21a inclined surface

1. A switch device comprising:
an operation unit that is provided with a light emitting region set at a part formed with a light-transmissive member, the operation unit being operated by pressing;
a support unit formed with a light-transmissive member and provided with an internal space formed to extend along a pressing direction in the operation by pressing, one end side in the pressing direction being connected to the light emitting region of the operation unit and supporting the operation unit;
a contact structure that is turned on and off by movement of the support unit along the pressing direction; and
a light emitting element that emits light toward the one end side from an other end side of the internal space of the support unit, wherein:
an external shape of the support unit in a substantially perpendicular direction to the pressing direction is formed smaller than the light emitting region; and
on an inner wall surface that forms the internal space of the support unit, a plurality of convex portions protruding from the inner wall surface are provided.

2. The switch device according to claim 1, wherein
the convex portion is formed in a streak shape extending along the pressing direction.

3. The switch device according to claim 2, wherein
an external surface of the convex portion is formed in a curved surface.

4. The switch device according to claim 2, wherein
the plurality of convex portions each formed in the streak shape extending along the pressing direction are arranged in parallel along an inner circumferential direction of the inner wall surface surrounding the internal space of the support unit.

5. The switch device according to claim 2, wherein
the convex portions each formed in the streak shape extending along the pressing direction are formed separately on the one end side and the other end side in the pressing direction sandwiching a predetermined location along the pressing direction.

6. The switch device according to claim 2, wherein
an end on the other end side in the pressing direction of the convex portion formed in the streak shape is formed with an inclined surface having a predetermined angle to the pressing direction.

7. The switch device according to claim 1, wherein
the operation unit and the support unit are formed with an integrally molded light-transmissive member.
